(19) United States
(12) Patent Application Publication
(10) Pub. No.: US 2025/0212112 A1
(43) Pub. Date: Jun. 26, 2025

(54) SERVICE PROCESSING METHOD AND APPARATUS, DEVICE, AND MEDIUM

(71) Applicant: Tencent Technology (Shenzhen) Company Limited, Shenzhen (CN)

(72) Inventors: Yuhang JIA, Shenzhen (CN); Yixue Lei, Shenzhen (CN)

(21) Appl. No.: 19/079,301

(22) Filed: Mar. 13, 2025

Related U.S. Application Data
(63) Continuation of application No. PCT/CN2023/130002, filed on Nov. 6, 2023.

(30) Foreign Application Priority Data
Feb. 17, 2023 (CN) 202310185490.6

(51) Int. Cl. H04W 48/20; H04W 24/02; H04W 48/08

(52) U.S. Cl. CPC H04W 48/20; H04W 24/02; H04W 48/08

(57) ABSTRACT

Embodiments of this application provide a service processing method performed by an electronic device acting as acting as an application-layer traffic optimization system, which is applicable to various scenes such as smart transportation, aided driving, cloud technologies, and artificial intelligence. The service processing method includes: obtaining network quality information respectively corresponding to a plurality of radio access nodes in a radio access network in response to a service request from a user equipment; obtaining application-layer traffic optimization information respectively corresponding to the plurality of radio access nodes, wherein the application-layer traffic optimization information is configured for representing resources of the radio access nodes; and selecting a target radio access node for processing a service request jointly from a plurality of radio access nodes based on network quality information and application-layer traffic optimization information respectively corresponding to a plurality of radio access nodes in a radio access network.

### CROSS-REFERENCE TO RELATED APPLICATIONS

This application is a continuation application of PCT Patent Application No. PCT/CN2023/130002, entitled “SERVICE PROCESSING METHOD AND APPARATUS, DEVICE, AND MEDIUM” filed on Nov. 6, 2023, which claims priority to Chinese Patent Application No. 2023101854906, entitled “SERVICE PROCESSING METHOD AND APPARATUS, DEVICE, AND MEDIUM” filed with the China National Intellectual Property Administration on Feb. 17, 2023, all of which are incorporated by reference in their entirety.

### FIELD OF THE TECHNOLOGY

This application relates to the field of communication technologies, and in particular, to a service processing method, a service processing apparatus, an electronic device, and a computer-readable medium.

### BACKGROUND OF THE DISCLOSURE

In a mobile wireless communications system such as a fifth-generation mobile communications system (5G), user equipment (UE) interacts with another UE by using a radio access network (RAN), a bearer network, a core network, the bearer network, and the radio access network to process a corresponding service.

A plurality of radio access nodes are deployed on the RAN. There is no clear solution in related art for how to properly select a radio access node to process a service request of the UE.

### SUMMARY

Embodiments of this application provide a service processing method and apparatus, a device, and a medium, to properly select a radio access node to process a service request of user equipment, thereby ensuring the properness in service processing.

In a first aspect, an embodiment of this application provides a service processing method performed by an electronic device acting as an application-layer traffic optimization system. The method includes: obtaining network quality information respectively corresponding to a plurality of radio access nodes in a radio access network in response to a service request from a user equipment; obtaining application-layer traffic optimization information respectively corresponding to the plurality of radio access nodes, where the application-layer traffic optimization information is configured for representing resources of the radio access nodes; and selecting a target radio access node for processing the service request from the plurality of radio access nodes based on the network quality information and the application-layer traffic optimization information.

In an embodiment of this application, based on the foregoing solution, after the selecting a target radio access node from the plurality of radio access nodes based on the network quality information and the application-layer traffic optimization information, the method further includes: transmitting the service request to the target radio access node, to cause the target radio access node to process the service request.

In an embodiment of this application, based on the foregoing solution, after the selecting a target radio access node from the plurality of radio access nodes based on the network quality information and the application-layer traffic optimization information, the method further includes: transmitting identifier information of the target radio access node to an application-layer traffic optimization client, to transmit the service request to the target radio access node by using the application-layer traffic optimization client, so as to cause the target radio access node to process the service request.

In a second aspect, an embodiment of this application provides a service processing apparatus performed by an electronic device acting as an application-layer traffic optimization system. The apparatus includes: a first obtaining module, configured to obtain network quality information respectively corresponding to a plurality of radio access nodes in a radio access network when receiving a service request from user equipment, where the network quality information is configured for representing network quality of a network environment in which the radio access nodes are located; a second obtaining module, configured to obtain application-layer traffic optimization information respectively corresponding to the plurality of radio access nodes, where the application-layer traffic optimization information is configured for representing resources of the radio access nodes; and a selection module, configured to select a target radio access node for processing the service request from the plurality of radio access nodes based on the network quality information and the application-layer traffic optimization information.

In a third aspect, an embodiment of this application provides an electronic device, including one or more processors; and a memory, configured to store one or more programs, the one or more programs, when executed by the one or more processors, causing the electronic device to implement the service processing method as described above.

In a fourth aspect, an embodiment of this application provides a non-transitory computer-readable medium, having a computer program stored therein, the computer program, when executed by a processor, implementing the service processing method as described above.

In a fifth aspect, an embodiment of this application provides a computer program product, including computer instructions, the computer instructions, when executed by a processor, implementing the service processing method as described above.

According to the technical solution provided in this embodiment of this application,

after receiving the service request of the user equipment, the application-layer traffic optimization system jointly selects the target radio access node for processing the service request from the plurality of radio access nodes based on the network quality information and the application-layer traffic optimization information respectively corresponding to the plurality of radio access nodes in the radio access network, thereby achieving proper selection of the target radio access node, and ensuring the properness in service processing.

To be specific, in this embodiment of this application, an application-layer traffic optimization technology is combined with a mobile wireless communications technology. In this way, the application-layer traffic optimization technology is applied to an underlying network, i.e. the radio access network. Based on two factors, i.e. the network quality information of the radio access node and the application-layer traffic optimization information, and by considering a network quality status of the network environment in which the radio access nodes are located and a resource status of the radio access nodes, the target radio access node for processing the service request can be determined more accurately and properly, resulting in more proper and timely processing of corresponding services.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an exemplary implementation environment in which a technical solution according to an embodiment of this application is applicable.

FIG. 2 is a flowchart of a service processing method according to an exemplary embodiment of this application.

FIG. 3 is a flowchart of a service processing method according to another exemplary embodiment of this application.

FIG. 4 is a flowchart of a service processing method according to another exemplary embodiment of this application.

FIG. 5 is a flowchart of a service processing method according to another exemplary embodiment of this application.

FIG. 6 is a flowchart of a service processing method according to another exemplary embodiment of this application.

FIG. 7 is a flowchart of a service processing method according to another exemplary embodiment of this application.

FIG. 8 is a schematic diagram of an exemplary implementation environment in which a technical solution according to an embodiment of this application is applicable.

FIG. 9 is a flowchart of a service processing method according to another exemplary embodiment of this application.

FIG. 10 is a flowchart of a service processing method according to another exemplary embodiment of this application.

FIG. 11 is a block diagram of a service processing apparatus according to an embodiment of this application.

FIG. 12 is a schematic structural diagram of a computer system suitable for implementing an electronic device according to an embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The following implementations described in the following exemplary embodiments do not represent all implementations that are consistent with this application. On the contrary, the implementations are merely examples of an apparatus and a method that are consistent with some aspects of this application described in detail in the appended claims.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or micro-controller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

In addition, “plurality of” mentioned in this application means two or more. The term “and/or” is configured for describing an association relationship between associated objects and representing that three relationships may exist. For example, A and/or B may represent the following three cases: only A exists, both A and B exist, and only B exists. The character “/” in this specification generally indicates an “or” relationship between the associated objects.

In a mobile wireless communications system such as a fifth-generation mobile communications system (5G), user equipment (UE) interacts with another UE by using a radio access network (RAN), a bearer network, a core network, the bearer network, and the radio access network to process a corresponding service. A plurality of radio access nodes are deployed on the RAN. There is no clear solution in related art for how to properly select a radio access node to process a service request of the UE.

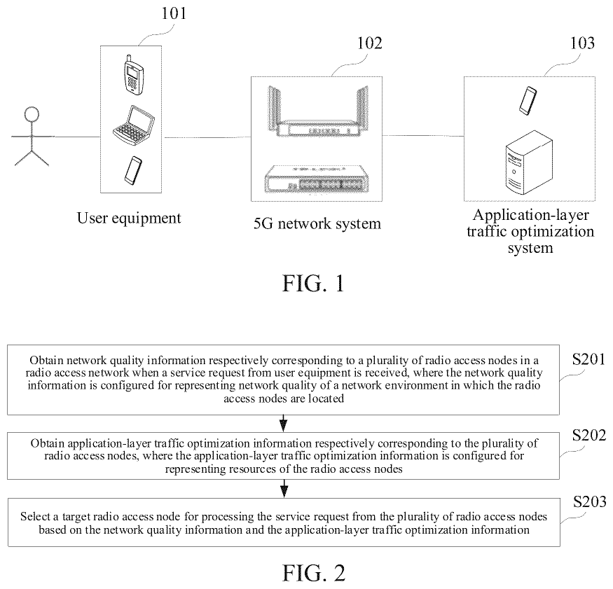

Therefore, this application provides a service processing solution. FIG. 1 is a schematic diagram of an implementation environment involved in this application. The implementation environment mainly includes user equipment 101, a 5G network system 102, and an application-layer traffic optimization (ALTO) system 103, where the user equipment 101 is a party initiating a service request, and corresponds to any electronic device of a user. The electronic device may be a smartphone, a tablet computer, a notebook computer, a computer, a smart speech interaction device, a smart household appliance, a smart wearable device, an aircraft, or the like.

The 5G network system 102 is a party for processing the service request. The 5G network system includes three layers, which are respectively a radio access network, a bearer network, and a core network. A corresponding network device is deployed on each layer. The network device may be a switch, a router, a hub, a network interface card, a modem, optical terminal equipment, an optical transceiver, a bridge, or the like.

The application-layer traffic optimization system 103 is established based on an application-layer traffic optimization protocol. The application-layer traffic optimization protocol is based on a client/server (C/S) structure, and uses a Java script object-notation (JSON) as an encoding format. This design enables the application-layer traffic optimization protocol to be flexible and extensible, and communication between an application-layer traffic optimization client and an application-layer traffic optimization server may be implemented by using the existing hypertext transfer protocol (HTTP). The communication between the application-layer traffic optimization client and the application-layer traffic optimization server in related art is applied to an upper-layer network, i.e. the Internet, such as a peer-to-peer (P2P) network or a content delivery network (CDN), and provides network-related information support for an application, to instruct the application to make a more proper selection of a candidate node, thereby enabling more proper processing of the service.

The application-layer traffic optimization client corresponds to any electronic device. In some embodiments, the electronic device may be a smartphone, a tablet computer, a notebook computer, a computer, a smart speech interaction device, a smart household appliance, a smart wearable device, an aircraft, or the like.

The application-layer traffic optimization server corresponds to a server that provides various services. For example, the server may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network, big data, and an artificial intelligence platform.

An implementation environment of this application combines the application-layer traffic optimization system and the 5G network system. Specifically, the application-layer traffic optimization system is applied to an underlying network, to make a proper selection of the corresponding radio access node for processing the service request of the user equipment from the radio access network of the 5G network system. In practical application, the application-layer traffic optimization system is applied to the underlying network, may be configured to process any service, and may be adjusted flexibly according to a specific application scene.

In addition, quantities of an electronic device corresponding to the user equipment 101, a network device corresponding to the 5G network system 102, an electronic device corresponding to the application-layer traffic optimization system 103, and servers in FIG. 1 are merely exemplary. In practical application, adjustment may be made flexibly according to a specific application scene.

In an embodiment of this application, the service processing method may be performed by an application-layer traffic optimization system 103.

For example, the service processing method may be specifically performed by an application-layer traffic optimization client in the application-layer traffic optimization system 103. When receiving a service request from user equipment, the application-layer traffic optimization client obtains network quality information respectively corresponding to a plurality of radio access nodes in a radio access network, where the network quality information is configured for representing network quality of a network environment in which the radio access nodes are located. Application-layer traffic optimization information respectively corresponding to the plurality of radio access nodes is obtained subsequently, where the application-layer traffic optimization information is configured for representing resources of the radio access nodes. Subsequently, a target radio access node for processing the service request is selected from the plurality of radio access nodes based on the network quality information and the application-layer traffic optimization information.

The application-layer traffic optimization client may be installed on the user equipment, or the user equipment performs data exchange with an electronic device on which the application-layer traffic optimization client is installed, to cause the user equipment to transmit the service request to the application-layer traffic optimization client.

For example, the service processing method may be specifically performed by an application-layer traffic optimization server in the application-layer traffic optimization system 103. When receiving a service request from user equipment, an application-layer traffic optimization server obtains network quality information respectively corresponding to a plurality of radio access nodes in a radio access network, where the network quality information is configured for representing network quality of a network environment in which the radio access nodes are located; Application-layer traffic optimization information respectively corresponding to the plurality of radio access nodes is obtained subsequently, where the application-layer traffic optimization information is configured for representing resources of the radio access nodes. Subsequently, a target radio access node for processing the service request is selected from the plurality of radio access nodes based on the network quality information and the application-layer traffic optimization information.

The application-layer traffic optimization client may be installed on the user equipment, or the user equipment performs data exchange with an electronic device on which the application-layer traffic optimization client is installed, to cause the user equipment to transmit the service request to the application-layer traffic optimization client. Further, the application-layer traffic optimization client transmits the service request to the application-layer traffic optimization server.

In an embodiment of this application, the service processing method may be performed by a network device having a control function in a 5G network system 102.

For example, when receiving a service request from user equipment, the network device obtains network quality information respectively corresponding to a plurality of radio access nodes in a radio access network, where the network quality information is configured for representing network quality of a network environment in which the radio access nodes are located. Application-layer traffic optimization information respectively corresponding to the plurality of radio access nodes is obtained subsequently, where the application-layer traffic optimization information is configured for representing resources of the radio access nodes. Subsequently, a target radio access node for processing the service request is selected from the plurality of radio access nodes based on the network quality information and the application-layer traffic optimization information.

The technical solution of the embodiment shown in FIG. 1 may be applied to various scenes, including but not limited to, smart transportation, aided driving, cloud technologies, artificial intelligence, or the like. In practical application, an adjustment may be correspondingly made according to a specific application scene.

For example, if the technical solution of this embodiment is applied to a scene of smart transportation or aided driving, the service may be an Internet-of-Vehicles service. Correspondingly, an in-vehicle terminal may transmit an Internet-of-Vehicles service request to a 5G network system, and subsequently an application-layer traffic optimization system properly selects a corresponding radio access node in a radio access network of the 5G network system for processing the Internet-of-Vehicles service request, to ensure the properness in Internet-of-Vehicles service processing.

For example, if the technical solution of this embodiment is applied to a scene of cloud technology or artificial intelligence, the service may be a cloud game service. Correspondingly, a smartphone may transmit a cloud game service request to the 5G network system, and subsequently the application-layer traffic optimization system properly selects a corresponding radio access node in a radio access network of the 5G network system for processing the cloud game service request, to ensure the properness in cloud game service processing.

In addition, in a specific implementation of this application, user-related data is involved. When the foregoing embodiments of this application are applied to specific products or technologies, permission or consent of the user needs to be obtained, and collection, use, and processing of the relevant data need to comply with relevant laws, regulations, and standards of relevant countries and regions.

Various implementation details of the technical solutions of the embodiments of this application are described in detail below.

FIG. 2 is a flowchart of a service processing method according to an embodiment of this application. The service processing method may be performed by an application-layer traffic optimization system 103. As shown in FIG. 2, the service processing method includes at least S201 to S203. Detailed descriptions are as follows:

S201: An application-layer traffic optimization system obtains network quality information respectively corresponding to a plurality of radio access nodes in a radio access network when receiving a service request from user equipment, where the network quality information is configured for representing network quality of a network environment in which the radio access nodes are located.

In this embodiment of this application, when a user has a service processing requirement, a service request may be transmitted by user equipment.

For example, the service processing method may be specifically performed by an application-layer traffic optimization client in the application-layer traffic optimization system. The application-layer traffic optimization client may be installed in the user equipment, or the user equipment may perform data exchange with an electronic device on which the application-layer traffic optimization client is installed. In this way, the user equipment may transmit the service request to the application-layer traffic optimization client. Correspondingly, the application-layer traffic optimization client receives the service request transmitted by the user equipment. To be specific, the application-layer traffic optimization client receives the service request from the user equipment.

For example, the service processing method may be specifically performed by an application-layer traffic optimization server in the application-layer traffic optimization system. The application-layer traffic optimization client may be installed in the user equipment, or the user equipment may perform data exchange with an electronic device on which the application-layer traffic optimization client is installed. In this way, the user equipment may transmit the service request to the application-layer traffic optimization client. Correspondingly, the application-layer traffic optimization client receives the service request of the user equipment. Subsequently, the application-layer traffic optimization client transmits the service request of the user equipment to the application-layer traffic optimization server. Correspondingly, the application-layer traffic optimization server receives the service request transmitted by the application-layer traffic optimization client. To be specific, the application-layer traffic optimization server receives the service request from the user equipment.

In this embodiment of this application, after receiving the service request from the user equipment, the application-layer traffic optimization system may obtain the network quality information respectively corresponding to the plurality of radio access nodes in the radio access network.

The radio access network of the 5G network system includes a plurality of radio access nodes, where
the radio access nodes in this embodiment of this application refer to network devices that can process the service request of the user equipment, and may be in any form, including, but not limited to, a switch, a router, and the like.

In this embodiment of this application, the network quality information corresponding to the radio access nodes is related to network quality of a network environment in which the radio access nodes are located. The network quality information may be any information related to the network quality, including, but not limited to network indicator information and network status information. The network indicator information may be throughput, delay, a packet loss rate, jitter, or the like. The network status information may be a received signal strength indication (RSSI), reference signal receiving power (RSRP), reference signal receiving quality (RSRQ), a signal to interference plus noise ratio (SINR), received signal code power (RSCP), or the like.

For example, in this embodiment of this application, the network quality information respectively corresponding to the plurality of radio access nodes may be collected/detected by the radio access network according to a specified collection/detection rule. For example, the network quality information is periodically collected/detected according to a specified frequency. Correspondingly, when receiving the service request from the user equipment, the application-layer traffic optimization system may obtain the network quality information, collected/detected by the radio access network, respectively corresponding to the plurality of radio access nodes from the radio access network.

For example, in this embodiment of this application, the network quality information respectively corresponding to the plurality of radio access nodes may be collected and detected by the radio access network when receiving a collection/detection instruction. Correspondingly, when receiving the service request from the user equipment, the application-layer traffic optimization system may obtain the network quality information, collected/detected by the radio access network, respectively corresponding to the plurality of radio access nodes from the radio access network.

S202: The application-layer traffic optimization system obtains application-layer traffic optimization information respectively corresponding to the plurality of radio access nodes, where the application-layer traffic optimization information is configured for representing resources of the radio access nodes.

In this embodiment of this application, after receiving the service request from the user equipment, the application-layer traffic optimization system may obtain the application-layer traffic optimization information respectively corresponding to the plurality of radio access nodes in the radio access network.

In this embodiment of this application, the application-layer traffic optimization information corresponding to the radio access nodes is related to the resources of the radio access nodes, and may be any information related to the resources, including, but not limited to resource use information, resource margin information, and the like. The resource use information is configured for representing a use status of the resource. The resource margin information is configured for representing a margin of the resource.

In this embodiment of this application, the resources of the radio access nodes include but are not limited to, storage resources, computing resources, and the like. The storage resources are required for storing service data related to the service request. The computing resource is required for performing corresponding logical computation on the service request.

For example, in this embodiment of this application, the application-layer traffic optimization information respectively corresponding to the plurality of radio access nodes may be obtained by the application-layer traffic optimization system by performing statistical analysis according to a specified statistics rule, for example, by performing periodic statistical analysis according to a specified frequency. Correspondingly, when receiving the service request from the user equipment, the application-layer traffic optimization system may obtain the network quality information respectively corresponding to the plurality of radio access nodes obtained by statistical analysis.

For example, in this embodiment of this application, the application-layer traffic optimization information respectively corresponding to the plurality of radio access nodes may be obtained by the application-layer traffic optimization system through statistical analysis when a statistics instruction is received. Correspondingly, when receiving the service request from the user equipment, the application-layer traffic optimization system may obtain the network quality information respectively corresponding to the plurality of radio access nodes obtained by statistical analysis.

S203: The application-layer traffic optimization system selects a target radio access node for processing the service request from a plurality of radio access nodes based on the network quality information and the application-layer traffic optimization information.

In this embodiment of this application, the application-layer traffic optimization system obtains the network quality information respectively corresponding to the plurality of radio access nodes and the application-layer traffic optimization information respectively corresponding to the plurality of radio access nodes, and subsequently may select the target radio access node for processing the service request from the plurality of radio access nodes based on the network quality information respectively corresponding to the plurality of radio access nodes and the application-layer traffic optimization information respectively corresponding to the plurality of radio access nodes.

In this embodiment of this application, the target radio access node is selected from the plurality of radio access nodes, and configured to process a currently received service request from the user equipment.

For example, it is assumed that the radio access nodes in the radio access network are numbered 110-119 respectively, and the radio access node 110 is selected from the radio access nodes 110-119 based on the network quality information and application-layer traffic optimization information respectively corresponding to the radio access nodes 110-119, the radio access node 110 is the target radio access node, and subsequently the service request is processed by the radio access node 110.

In addition, a process of obtaining the network quality information respectively corresponding to the plurality of radio access nodes in the radio access network in S201 and a process of obtaining the application-layer traffic optimization information respectively corresponding to the plurality of radio access nodes in S202 shown in FIG. 2 may be performed in parallel or may be performed in any exchange sequence. In practical application, adjustment may be made flexibly according to a specific application scene.

In the embodiments of this application, an application-layer traffic optimization technology is combined with a mobile wireless communications technology. In this way, the application-layer traffic optimization technology is applied to an underlying network (i.e. the radio access network). In addition, by considering a network quality status of the network environment in which the radio access nodes are located and a resource status of the radio access nodes, the target radio access node for processing the service request can be determined more accurately and properly, thereby ensuring more proper and timely processing of the corresponding service.

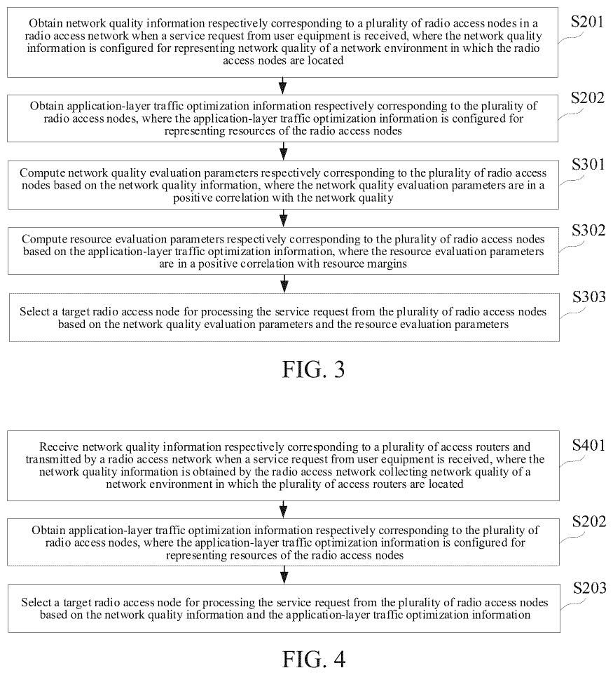

An embodiment of this application provides another service processing method. The service processing method may be performed by an application-layer traffic optimization system 103. As shown in FIG. 3, the service processing method may include S301 to S303, and S201 to S202.

Detailed descriptions of S301 to S303 are as follows:

S301: An application-layer traffic optimization system computes network quality evaluation parameters respectively corresponding to a plurality of radio access nodes based on network quality information, where the network quality evaluation parameters are in a positive correlation with the network quality.

In this embodiment of this application, the application-layer traffic optimization system obtains the network quality information respectively corresponding to the plurality of radio access nodes, and subsequently may compute the network quality evaluation parameters respectively corresponding to the plurality of radio access nodes based on the network quality information respectively corresponding to the plurality of radio access nodes.

In this embodiment of this application, the network quality evaluation parameter is configured for representing a status of network quality corresponding to a network environment in which the radio access nodes are located. For example, the network quality evaluation parameter may be configured for representing a good network quality, or the network quality evaluation parameter may be configured for representing a medium network quality, or the network quality evaluation parameter may be configured for representing a poor network quality.

The network quality evaluation parameter is in a positive correlation with the network quality. To be specific, a larger numerical value corresponding to the network quality evaluation parameter indicates better network quality. Otherwise, a smaller numerical value corresponding to the network quality evaluation parameter indicates poorer network quality.

For example, an example in which the network quality evaluation parameter is in a hundred-point system is used. Referring to the following Table 1, an example in which the network quality evaluation parameter is in a positive correlation with network quality is shown.

TABLE 1

| Network quality evaluation parameter | Network quality |
|---|---|
| 95 | Good |
| 70 | Medium |
| 50 | Poor |

In practical application, a reference point system of the network quality evaluation parameter may be adjusted flexibly according to a specific application scene. For example, a ten-point system, a millage system, or the like may alternatively be used.

In an embodiment of this application, the network quality information includes numerical values corresponding to a plurality of different types of network indicators. As described in the foregoing embodiments, a network indicator may be throughput, delay, a packet loss rate, jitter, and the like. The throughput, the delay, the packet loss rate, and the jitter are different types of network indicators. In practical application, the type of the network indicator for the network quality information may be adjusted flexibly according to a specific application scene.

For example, it is assumed that the network quality information includes numerical values corresponding to two types of network indicators, i.e. the delay and the packet loss rate. Q is configured for representing the network quality information, d is configured for representing the delay, and l is configured for representing the packet loss rate, and therefore, the network quality information of each radio access node is Q=[d, l].

Correspondingly, a process in which the application-layer traffic optimization system computes network quality evaluation parameters respectively corresponding to the plurality of radio access nodes based on the network quality information in S301 may include:

For each radio access node, the application-layer traffic optimization system computes a network quality evaluation parameter corresponding to the radio access node based on numerical values corresponding to a plurality of different types of network indicators.

Specifically, in an alternative embodiment, a process of computing the network quality evaluation parameter of each radio access node is that the application-layer traffic optimization system computes the network quality evaluation parameter corresponding to the radio access nodes based on the numerical values corresponding to the plurality of different types of network indicators.

For example, following the foregoing example, it is assumed that there are ten radio access nodes 110 to 119 in total. A process of computing the network quality evaluation parameter of the radio access node 110 is used as an example. In addition, it is assumed that the network quality information of the radio access node 110 be Q110=[d110, l110], the network quality evaluation parameter of the radio access node 110 is computed based on d110 and l110. The process of computing the network quality evaluation parameters of the other radio access nodes 111 to 119 may be performed in a same manner.

For example, a process in which the application-layer traffic optimization system computes the network quality evaluation parameter corresponding to the radio access node based on the numerical values corresponding to the plurality of different types of network indicators may include:
The application-layer traffic optimization system obtains weight values respectively corresponding to different types of network indicators;
The application-layer traffic optimization system performs a multiplication operation on the weight value and the numerical value corresponding to a same type of network indicator, to obtain a first operation result; and
The application-layer traffic optimization system performs a summation operation on the first operation results respectively corresponding to the plurality of types of network indicators, to obtain a second operation result; and
The application-layer traffic optimization system uses the second operation result as the network quality evaluation parameter corresponding to the radio access node.

For example, still following the foregoing example, d′ is configured for representing the weight value of delay, l′ is configured for representing the weight value of packet loss rate, and therefore, the first operation result is d′*d110 and l′*l110, the second operation result is d′*d110+1′*l110. In this case, the second operation result d′*d110+l′*l110 is the network quality evaluation parameter corresponding to the radio access node 110. The process of computing the network quality evaluation parameters of the other radio access nodes 111 to 119 may be performed in a same manner.

In an embodiment of this application, the network quality information includes a numerical value corresponding to one type of network indicator. Correspondingly, a process of computing the network quality evaluation parameters respectively corresponding to the plurality of radio access nodes based on the network quality information in S301 may include:

For each radio access node, the application-layer traffic optimization system computes a network quality evaluation parameter corresponding to the radio access node based on the numerical value corresponding to one type of network indicator.

For example, a process in which the application-layer traffic optimization system computes the network quality evaluation parameter corresponding to the radio access node based on the numerical value corresponding to one type of network indicator may include:
The application-layer traffic optimization system obtains a weight value corresponding to the network indicator;
The application-layer traffic optimization system performs a multiplication operation on the weight value and the numerical value that correspond to the network indicator, to obtain a third operation result; and
The application-layer traffic optimization system uses the third operation result as the network quality evaluation parameter corresponding to the radio access node.

For details that the network quality information includes the numerical value corresponding to one type of network indicator, refer to the foregoing descriptions, and details are not described herein again.

S302: The application-layer traffic optimization system computes resource evaluation parameters respectively corresponding to the plurality of radio access nodes based on the application-layer traffic optimization information, where the resource evaluation parameters are in a positive correlation with resource margins.

In this embodiment of this application, the application-layer traffic optimization system obtains the application-layer traffic optimization information respectively corresponding to the plurality of radio access nodes, and subsequently may compute the resource evaluation parameters respectively corresponding to the plurality of radio access nodes based on the application-layer traffic optimization information respectively corresponding to the plurality of radio access nodes.

In this embodiment of this application, the resource evaluation parameter is configured for representing a quantity/amount of resource margins of the radio access nodes. For example, the resource evaluation parameter may be configured for representing a large resource margin, the resource evaluation parameter may be configured for representing a medium resource margin, or the resource evaluation parameter may be configured for representing a little resource margin.

The resource evaluation parameter is in a positive correlation with the resource margin. Specifically, a larger numerical value corresponding to the resource evaluation parameter indicates a larger resource margin. Otherwise, a smaller numerical value corresponding to the resource evaluation parameter indicates less resource margin.

For example, an example in which the resource evaluation parameter is in a hundred-point system is used. Referring to the following Table 2, an example in which the resource evaluation parameter is in a positive correlation with the resource margin is shown.

TABLE 2

| Resource evaluation parameter | Resource margin |
|---|---|
| 92 | Large |
| 75 | Medium |
| 56 | Small |

In practical application, a reference point system of the network quality evaluation parameter may be adjusted flexibly according to a specific application scene. For example, a ten-point system, a millage system, or the like may alternatively be used.

In an embodiment of this application, the application-layer traffic optimization information includes numerical values corresponding to a plurality of different types of resources. As described in the foregoing embodiments, the resource may be a storage resource, a computing resource, and the like. Specifically, the storage resource and the computing resource are different types of resources. In practical application, the type of resources for the application-layer traffic optimization information may be adjusted flexibly according to a specific application scene.

For example, it is assumed that the application-layer traffic optimization information includes numerical values corresponding to two types of resources, i.e. a storage resource and a computing resource. O is configured for representing the application-layer traffic optimization information, s is configured for representing the storage resource, c is configured for representing the computing resource, and therefore, the application-layer traffic optimization information of each radio access node is O=[s, c].

Correspondingly, a process in which the application-layer traffic optimization system computes the resource evaluation parameters respectively corresponding to the plurality of radio access nodes based on the application-layer traffic optimization information in S302 may include:

For each radio access node, the application-layer traffic optimization system computes a resource evaluation parameter corresponding to the radio access node based on numerical values corresponding to the plurality of different types of resources.

Specifically, in an alternative embodiment, a process of computing the resource evaluation parameter of each radio access node is that the resource evaluation parameters corresponding to the radio access nodes are computed based on the numerical values corresponding to different types of resources.

For example, following the foregoing example, it is assumed that there are ten radio access nodes 110 to 119 in total. A process of computing the resource evaluation parameter of the radio access node 110 is taken as an example. In addition, it is assumed that the application-layer traffic optimization information of the radio access node 110 is O110=[s110, c110]. Therefore, the resource evaluation parameter of the radio access node 110 is computed based on s110 and c110. The resource evaluation parameters of the other radio access nodes 111 to 119 may be computed in the same manner.

For example, a process in which the application-layer traffic optimization system computes the resource evaluation parameter corresponding to the radio access node based on the numerical values corresponding to different types of resources may include:
The application-layer traffic optimization system obtains weight values respectively corresponding to different types of resources;
the application-layer traffic optimization system performs a multiplication operation on the weight value and the numerical value corresponding to the same type of resources, to obtain a fourth operation result;
the application-layer traffic optimization system performs a summation operation on the fourth operation results respectively corresponding to the plurality of types of resources, to obtain a fifth operation result; and
the application-layer traffic optimization system takes the fifth operation result as the resource evaluation parameter corresponding to the radio access node.

For example, still following the foregoing example, s′ is configured for representing the weight value of storage resource, c′ is configured for representing the weight value of computing resources, and therefore, the fourth operation result is s′*s110 and c′*c110, and the fifth operation result is s′*s110+c′*c110. In this case, the fifth operation result s′*s110+c′*c110 is the resource evaluation parameter corresponding to the radio access node 110. The resource evaluation parameters of the other radio access nodes 111 to 119 may be computed in the same manner.

In an embodiment of this application, the application-layer traffic optimization information includes a numerical value corresponding to one type of resources. Correspondingly, a process in which the application-layer traffic optimization system computes the resource evaluation parameters respectively corresponding to the plurality of radio access nodes based on the application-layer traffic optimization information in S302 may include:

For each radio access node, the application-layer traffic optimization system computes a resource evaluation parameter corresponding to the radio access node based on the numerical value corresponding to one type of resources.

For example, a process in which the application-layer traffic optimization system computes the resource evaluation parameter corresponding to the radio access node based on the numerical value corresponding to one type of resources may include:
The application-layer traffic optimization system obtains a weight value corresponding to the resource;
the application-layer traffic optimization system performs a multiplication operation on the weight value and the numerical value corresponding to the resource, to obtain a sixth operation result; and
the application-layer traffic optimization system takes the sixth operation result as the resource evaluation parameter corresponding to the radio access node.

For a specific situation that the application-layer traffic optimization information includes the numerical value corresponding to one type of resources, refer to the foregoing description, and details are not described herein again.

S303: The application-layer traffic optimization system selects a target radio access node for processing the service request from the plurality of radio access nodes based on the network quality evaluation parameter and the resource evaluation parameter.

In this embodiment of this application, the application-layer traffic optimization system computes the network quality evaluation parameters respectively corresponding to the plurality of radio access nodes and the resource evaluation parameters respectively corresponding to the plurality of radio access nodes, and subsequently may select the target radio access node for processing the service request from the plurality of radio access nodes.

In an embodiment of this application, a process in which the application-layer traffic optimization system selects a target radio access node for processing the service request from the plurality of radio access nodes based on the network quality evaluation parameter and the resource evaluation parameter in S303 may include:
The application-layer traffic optimization system selects a radio access node corresponding to that the network quality evaluation parameter is greater than a preset network quality evaluation threshold and the resource evaluation parameter is greater than a preset resource evaluation threshold from a plurality of radio access nodes; and
the application-layer traffic optimization system uses the selected radio access node as the target radio access node for processing the service request.

To be specific, in an alternative embodiment, the radio access node corresponding to that the network quality evaluation parameter is greater than the network quality evaluation threshold and the resource evaluation parameter is greater than the preset resource evaluation threshold is selected from the plurality of radio access nodes as the target radio access node. In short, the target radio access node simultaneously satisfies two conditions that the network quality evaluation parameter is greater than the preset network quality evaluation threshold, and the resource evaluation parameter is greater than the preset resource evaluation threshold. In practical application, the preset network quality evaluation threshold and the preset resource evaluation threshold may be adjusted flexibly according to a specific application scene.

For example, a process in which the application-layer traffic optimization system selects a radio access node corresponding to that the network quality evaluation parameter is greater than the preset network quality evaluation threshold and the resource evaluation parameter is greater than the preset resource evaluation threshold from the plurality of radio access nodes may include:
The application-layer traffic optimization system selects a first candidate radio access node corresponding to that the network quality evaluation parameter is greater than the preset network quality evaluation threshold from the plurality of radio access nodes, and selects the radio access node corresponding to that the resource evaluation parameter is greater than the preset resource evaluation threshold from the first candidate radio access nodes.

To be specific, in an alternative embodiment, the application-layer traffic optimization system may first select the first candidate radio access node corresponding to that the network quality evaluation parameter is greater than the preset network quality evaluation threshold from the plurality of radio access nodes, and then select the radio access node corresponding to that the resource evaluation parameter is greater than the preset resource evaluation threshold from the first candidate radio access nodes. In this way, the accuracy of the selected target radio access node can be improved to certain extent by performing layer-by-layer selection.

For example, a process in which the application-layer traffic optimization system selects a radio access node corresponding to that the network quality evaluation parameter is greater than the preset network quality evaluation threshold and the resource evaluation parameter is greater than the preset resource evaluation threshold from the plurality of radio access nodes may include:

The application-layer traffic optimization system selects a second candidate radio access node corresponding to that the resource evaluation parameter is greater than a preset resource evaluation threshold from the plurality of radio access nodes, and selects a radio access node corresponding to that the network quality evaluation parameter is greater than a preset network quality evaluation threshold from the second candidate radio access nodes.

Specifically, in an alternative embodiment, the application-layer traffic optimization system may first select the second candidate radio access node corresponding to that the resource evaluation parameter is greater than the preset resource evaluation threshold from the plurality of radio access nodes, and then selects the radio access node corresponding to that the network quality evaluation parameter is greater than the preset network quality evaluation threshold from the second candidate radio access nodes. In this way, the accuracy of the selected target radio access node can be improved to certain extent by performing layer-by-layer selection.

In addition, a process in which the application-layer traffic optimization system computes the network quality evaluation parameters respectively corresponding to the plurality of radio access nodes based on the network quality information in S301, and a process in which the application-layer traffic optimization system computes the resource evaluation parameters respectively corresponding to the plurality of radio access nodes based on the application-layer traffic optimization information in S302 shown in FIG. 3 may be performed in parallel, or may be performed in any exchange sequence. In practical application, adjustment may be made flexibly according to a specific application scene.

In addition, for detailed descriptions of S201 to S202 shown in FIG. 3, refer to S201 to S202 shown in FIG. 2. Details are not described herein again.

In this embodiment of this application, the application-layer traffic optimization system computes the network quality evaluation parameters respectively corresponding to the plurality of radio access nodes based on the network quality information, and computes the resource evaluation parameters respectively corresponding to the plurality of radio access nodes based on the application-layer traffic optimization information. In this way, the target radio access node for processing the service request is selected by means of the quantized network quality evaluation parameter and resource evaluation parameter, so that the target radio access node for processing the service request can be determined more directly and accurately, resulting in more proper and timely processing of corresponding service.

An embodiment of this application provides another service processing method. The service processing method may be performed by an application-layer traffic optimization system 103. As shown in FIG. 4, the service processing method may include S401, and S202 to S203.

A radio access node in this embodiment of this application includes an access router.

S401 is described in detail below:

S401: An application-layer traffic optimization system receives network quality information, transmitted by a radio access network, respectively corresponding to a plurality of access routers, where the network quality information is obtained by the radio access network collecting network quality of a network environment in which the plurality of access routers are located.

As described in the foregoing embodiments, the radio access network may collect/detect the network quality of the network environment in which the plurality of radio access nodes are located, to obtain the network quality information respectively corresponding to the plurality of radio access nodes.

In this embodiment of this application, when the radio access node includes the access router, the radio access network collects/detects the network quality of the network environment in which the plurality of access routers are located, to obtain the network quality information respectively corresponding to the plurality of access routers, and subsequently the radio access network transmits the network quality information respectively corresponding to the plurality of access routers to the application-layer traffic optimization system. Correspondingly, the application-layer traffic optimization system receives the network quality information respectively corresponding to the plurality of access routers transmitted by the radio access network.

In an embodiment of this application, a process in which the application-layer traffic optimization system receives the network quality information respectively corresponding to a plurality of access routers transmitted by the radio access network in S401 may include:

The application-layer traffic optimization system receives the network quality information respectively corresponding to the plurality of access routers transmitted by the radio access network successively through a plurality of network devices in a core network.

The core network includes a plurality of network devices, including, but not limited to an access and mobility management function (AMF), a session management function (SMF), a policy control function (PCF), a network exposure function (NEF), an application function (AF), or the like.

For example, the radio access network transmits the network quality information respectively corresponding to the plurality of access routers to the application-layer traffic optimization system sequentially by using the access and mobility management function, the session management function, the policy control function, the network exposure function, and the application function in the core network. The network quality information respectively corresponding to each access router is converted into a data transmission format corresponding to a corresponding network device to be transmitted to the corresponding network device.

In addition, for detailed descriptions of S202 to S203 shown in FIG. 4, refer to S202 to S203 shown in FIG. 2. Details are not described herein again.

In this embodiment of this application, the application-layer traffic optimization system receives the network quality information respectively corresponding to the plurality of access routers transmitted by the radio access network, so as to obtain the network quality information respectively corresponding to the plurality of access routers in the radio access network, thereby providing strong support for the subsequent selection of a target radio access node for processing a service request. Furthermore, the process is simple, easy to implement, and applicable to many application scenes.

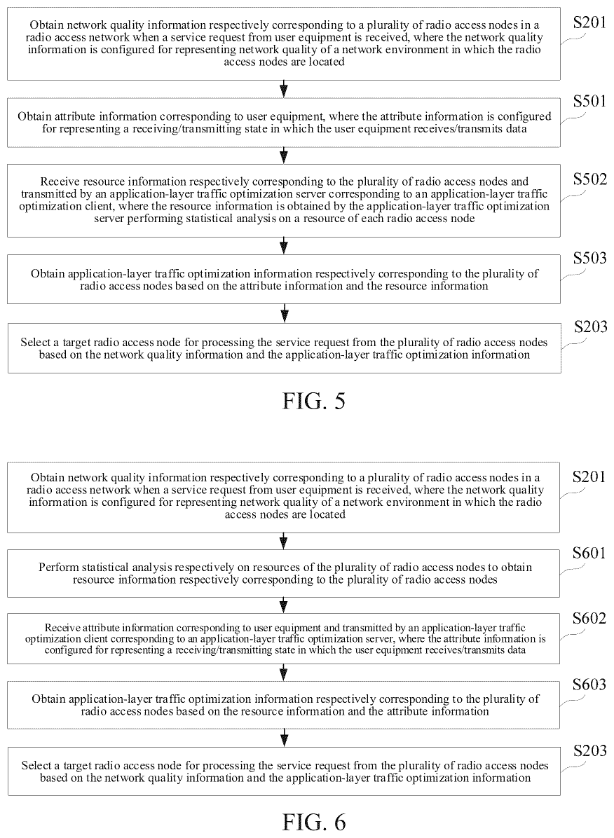

An embodiment of this application provides another service processing method. The service processing method may be performed by an application-layer traffic optimization system 103. As shown in FIG. 5, the service processing method may include S501 to S503, S201, and S203.

The service processing method in this embodiment of this application is specifically performed by an application-layer traffic optimization client in the application-layer traffic optimization system 103.

Detailed descriptions of S501 to S503 are as follows:

S501: An application-layer traffic optimization client obtains attribute information corresponding to user equipment. The attribute information is configured for representing a receiving/transmitting state in which the user equipment receives/transmits data.

Because the application-layer traffic optimization client may be installed in the user equipment, or an electronic device on which the application-layer traffic optimization client is installed may perform data exchange with the user equipment, the application-layer traffic optimization client may obtain the attribute information corresponding to the user equipment.

In this embodiment of this application, the attribute information of the user equipment is related to a receiving/transmitting state in which the user equipment receives/transmits data. The receiving/transmitting state is a state in which the user equipment receives the data and/or a state in which the user equipment transmits the data. The received and transmitted data may be any data.

S502: An application-layer traffic optimization client receives resource information respectively corresponding to a plurality of radio access nodes and transmitted by an application-layer traffic optimization server corresponding to the application-layer traffic optimization client. The resource information is obtained by the application-layer traffic optimization server through statistical analysis of the resources on each radio access node.

As described in the foregoing embodiment, the application-layer traffic optimization system may perform statistical analysis on the resources of the plurality of radio access nodes, to obtain the resource information respectively corresponding to the plurality of radio access nodes.

In this embodiment of this application, the application-layer traffic optimization server corresponding to the application-layer traffic optimization client in the application-layer traffic optimization system performs statistical analysis on the resources of the plurality of radio access nodes, to obtain the resource information respectively corresponding to the plurality of radio access nodes, and then the application-layer traffic optimization server transmits the resource information respectively corresponding to the plurality of radio access nodes to the application-layer traffic optimization client. Correspondingly, the application-layer traffic optimization client receives the resource information respectively corresponding to a plurality of radio access nodes transmitted by the application-layer traffic optimization server.

S503. The application-layer traffic optimization client obtains application-layer traffic optimization information respectively corresponding to the plurality of radio access nodes based on the attribute information and the resource information.

In this embodiment of this application, the application-layer traffic optimization client obtains the attribute information corresponding to the user equipment and receives the resource information respectively corresponding to the plurality of radio access nodes, and may subsequently obtain the application-layer traffic optimization information respectively corresponding to the plurality of radio access nodes based on the attribute information corresponding to the user equipment and the resource information respectively corresponding to the plurality of radio access nodes.

Because the attribute information corresponding to the user equipment is configured for representing a receiving/transmitting state in which the user equipment receives/transmits data, the receiving/transmitting state in which the user equipment receives/transmits the data may reflect a resource status of the radio access node receiving/transmitting the data. For example, the faster transmission of data by the user equipment may reflect faster receiving of data by the radio access node to certain extent. Correspondingly, a resource margin of the radio access node receiving the data is relatively sufficient. The faster receiving of data by the user equipment may reflect the faster transmission of data by the radio access node to certain extent. Correspondingly, the resource margin of the radio access node transmitting the data is relatively sufficient.

Therefore, in this embodiment of this application, the application-layer traffic optimization information respectively corresponding to the plurality of radio access nodes obtained based on the attribute information corresponding to the user equipment and the resource information respectively corresponding to the plurality of radio access nodes is more accurate.

In an embodiment of this application, after a process in which the application-layer traffic optimization client selects a target radio access node for processing the service request from the plurality of radio access nodes based on the network quality information and the application-layer traffic optimization information in S203, the method may further include:

The application-layer traffic optimization client transmits the service request to the target radio access node, to cause the target radio access node to process the service request.

To be specific, in an alternative embodiment, the application-layer traffic optimization client selects the target radio access node for processing the service request from the plurality of radio access nodes based on the network quality information respectively corresponding to the plurality of radio access nodes and the application-layer traffic optimization information respectively corresponding to the plurality of radio access nodes, and may subsequently transmit the service request to the target radio access node. Correspondingly, after receiving the service request transmitted by the application-layer traffic optimization client, the target radio access node processes the service request, to complete a service corresponding to the service request.

In addition, a process in which the application-layer traffic optimization client obtains the attribute information corresponding to the user equipment in S501, and a process in which the application-layer traffic optimization client receives the resource information respectively corresponding to the plurality of radio access nodes and transmitted by the application-layer traffic optimization server corresponding to the application-layer traffic optimization client in S502 shown in FIG. 5 may be performed in parallel, or may be performed in any exchange sequence. In practical application, adjustment may be made flexibly according to a specific application scene.

In addition, for detailed descriptions of S201 and S203 shown in FIG. 5, refer to S201 and S203 shown in FIG. 2. Details are not described herein again.

In this embodiment of this application, the application-layer traffic optimization client obtains the attribute information corresponding to the user equipment and receives the resource information respectively corresponding to the plurality of radio access nodes and transmitted by the application-layer traffic optimization server, so as to obtain the application-layer traffic optimization information respectively corresponding to the plurality of radio access nodes, thereby providing strong support for subsequent selection of the target radio access node for processing the service request. Furthermore, the process is simple, easy to implement, and applicable to many application scenes.

An embodiment of this application provides another service processing method. The service processing method may be performed by an application-layer traffic optimization system 103. As shown in FIG. 6, the service processing method may include S601 to S603, S201, and S203.

The service processing method in this embodiment of this application is specifically performed by an application-layer traffic optimization server in the application-layer traffic optimization system 103.

Detailed descriptions of S601 to S603 are as follows:

S601: An application-layer traffic optimization server performs statistical analysis respectively on resources of a plurality of radio access nodes, to obtain resource information respectively corresponding to the plurality of radio access nodes.

As described in the foregoing embodiment, the application-layer traffic optimization system may perform statistical analysis on the resources of the plurality of radio access nodes, to obtain the resource information respectively corresponding to the plurality of radio access nodes.

In this embodiment of this application, the application-layer traffic optimization server in the application-layer traffic optimization system performs the statistical analysis on the resources of the plurality of radio access nodes, to obtain the resource information respectively corresponding to the plurality of radio access nodes.

S602: The application-layer traffic optimization server receives attribute information corresponding to user equipment and transmitted by an application-layer traffic optimization client corresponding to the application-layer traffic optimization server. The attribute information is configured for representing a receiving/transmitting state in which the user equipment receives/transmits data.

In this embodiment of this application, the application-layer traffic optimization client corresponding to the application-layer traffic optimization server in the application-layer traffic optimization system may be installed in the user equipment, or an electronic device on which the application-layer traffic optimization client is installed may perform data exchange with the user equipment. In this way, the application-layer traffic optimization client may obtain the attribute information corresponding to the user equipment, and subsequently, the application-layer traffic optimization client transmits the attribute information corresponding to the user equipment to the application-layer traffic optimization server. Correspondingly, the application-layer traffic optimization server receives the attribute information corresponding to the user equipment transmitted by the application-layer traffic optimization client.

In this embodiment of this application, the attribute information of the user equipment is related to a receiving/transmitting state in which the user equipment receives/transmits data. The receiving/transmitting state is a state in which the user equipment receives the data and/or a state in which the user equipment transmits the data. The received and transmitted data may be any data.

S603: The application-layer traffic optimization server obtains application-layer traffic optimization information respectively corresponding to a plurality of radio access nodes based on the resource information and the attribute information.

In this embodiment of this application, the application-layer traffic optimization server obtains, by statistical analysis, the resource information respectively corresponding to the plurality of radio access nodes and receives the attribute information corresponding to the user equipment and may subsequently obtain the application-layer traffic optimization information respectively corresponding to the plurality of radio access nodes based on the resource information respectively corresponding to the plurality of radio access nodes and the attribute information corresponding to the user equipment.

Because the attribute information corresponding to the user equipment is configured for representing a receiving/transmitting state in which the user equipment receives/transmits data, the receiving/transmitting state in which the user equipment receives/transmits the data may reflect a resource status of the radio access node receiving/transmitting the data. For example, the faster transmission of data by the user equipment may reflect faster receiving of data by the radio access node to certain extent. Correspondingly, a resource margin of the radio access node receiving the data is relatively sufficient. The faster receiving of data by the user equipment may reflect the faster transmission of data by the radio access node to certain extent. Correspondingly, the resource margin of the radio access node transmitting the data is relatively sufficient.

Therefore, in this embodiment of this application, the application-layer traffic optimization information, respectively corresponding to the plurality of radio access nodes, obtained based on the resource information respectively corresponding to the plurality of radio access nodes and the attribute information corresponding to the user equipment is more accurate.

In an embodiment of this application, after a process in which the application-layer traffic optimization server selects a target radio access node for processing the service request from the plurality of radio access nodes based on the network quality information and the application-layer traffic optimization information in S203, the method may further include:

The application-layer traffic optimization server transmits identifier information of the target radio access node to the application-layer traffic optimization client, so as to transmit the service request to the target radio access node by using the application-layer traffic optimization client, causing the target radio access node to process the service request.

To be specific, in an alternative embodiment, the application-layer traffic optimization server selects the target radio access node for processing the service request from the plurality of radio access nodes based on the network quality information respectively corresponding to the plurality of radio access nodes and the application-layer traffic optimization information respectively corresponding to the plurality of radio access nodes, and may subsequently transmit the identifier information of the target radio access node to the application-layer traffic optimization client. Correspondingly, the application-layer traffic optimization client receives the identifier information of the target radio access node transmitted by the application-layer traffic optimization server. Subsequently, the application-layer traffic optimization client transmits the service request to the target radio access node matching the identifier information of the target radio access node. Correspondingly, after receiving the service request transmitted by the application-layer traffic optimization client, the target radio access node processes the service request, to complete a service corresponding to the service request.

In addition, a process in which the statistical analysis is performed respectively on the resources of the plurality of radio access nodes to obtain resource information respectively corresponding to the plurality of radio access nodes in S601, and a process in which the attribute information corresponding to user equipment transmitted by the application-layer traffic optimization client corresponding to the application-layer traffic optimization server in S602 shown in FIG. 6 may be performed in parallel, or may be performed in any exchange sequence. In practical application, adjustment may be made flexibly according to a specific application scene.

In addition, for detailed descriptions of S201 and S203 shown in FIG. 6, refer to S201 and S203 shown in FIG. 2. Details are not described herein again.

In this embodiment of this application, the application-layer traffic optimization server obtains, by statistical analysis, the resource information respectively corresponding to the plurality of radio access nodes and receives the attribute information corresponding to the user equipment transmitted by the application-layer traffic optimization client, so as to obtain the application-layer traffic optimization information respectively corresponding to the plurality of radio access nodes, thereby providing strong support for subsequent selection of the target radio access node for processing the service request. Furthermore, the process is simple, easy to implement, and applicable to many application scenes.

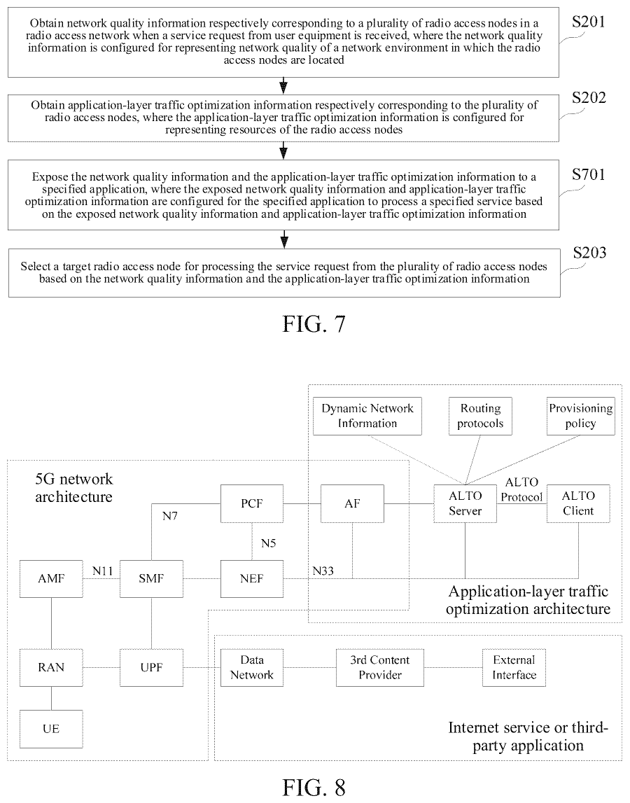

An embodiment of this application provides another service processing method. The service processing method may be performed by an application-layer traffic optimization system 103. As shown in FIG. 7, the service processing method may further include S701 after S202.

S701 is described in detail below:

S701: The application-layer traffic optimization system exposes network quality information and application-layer traffic optimization information to a specified application, where the exposed network quality information and application-layer traffic optimization information are configured for the specified application to process a specified service based on the exposed network quality information and application-layer traffic optimization information.

In this embodiment of this application, after obtaining the network quality information respectively corresponding to the plurality of radio access nodes and the application-layer traffic optimization information respectively corresponding to the plurality of radio access nodes, the application-layer traffic optimization system may subsequently expose the network quality information respectively corresponding to the plurality of radio access nodes and the application-layer traffic optimization information respectively corresponding to the plurality of radio access nodes to the specified application. In this way, the specified application may process the specified service based on the exposed network quality information respectively corresponding to the plurality of radio access nodes and the exposed application-layer traffic optimization information respectively corresponding to the plurality of radio access nodes.

The specified application in this embodiment of this application may be installed on user equipment, or may alternatively be installed on another electronic device. The application may be a third-party application. In practical application, the specified application may be adjusted flexibly according to a specific application scene.

In addition, S701 shown in FIG. 7 may be performed before S203 or after S203. Furthermore, for detailed descriptions of S201 to S203 shown in FIG. 7, refer to S201 to S203 shown in FIG. 2. Details are not described herein again.

In this embodiment of this application, the network quality information and application-layer traffic optimization information respectively corresponding to the plurality of radio access nodes are exposed. In this way, the specified application may process a corresponding service by using the exposed network quality information and application-layer traffic optimization information respectively corresponding to the plurality of radio access nodes, thereby providing strong support for the specified application to process the service, and being suitable for a wider range of application scenes.

A specific scene of this embodiment of this application is described in detail below:

FIG. 8 mainly shows a 5G network architecture, an application-layer traffic optimization architecture, and an Internet service or a third-party application, where
for example, the 5G network architecture mainly includes a UE, an RAN, an AMF, an SMF, a PCF, a NEF, an AF, and a user plane function (UPF), where
the AMF is a core network control plane access point, and is mainly configured to perform registration, connection, reachability, mobility management, and the like. The AMF provides a session management and message transmission channel for the UE and the SMF, and provides functions such as authentication for user access.

The SMF is mainly configured to maintain a tunnel, allocate and manage an IP address, select a UPF, implement a policy, control in a QoS, collect charging data, roam, and the like.

The PCF is mainly configured to provide policy rules for control plane functions.

The NEF is located between a 5G core network and external application functions (or some internal AF), and mainly configured to manage exposed network data, and provide corresponding security guarantee to ensure the security of external applications to 3GPP network, and provide functions such as QoS customization exposure ability of external applications, mobility state event subscription, and AF request distribution.

The AF may be configured to implement a control plane function of an external application, and may specifically perform interaction by using an AF-NEF-PCF or an AF-PCF; or may be configured to implement a user plane function of an external application, and may specifically perform interaction by using an AS-IP transport network-UPF interface.

The UPF is mainly responsible for packet routing and forwarding, policy implementation, traffic reporting, QoS handling, and the like.

For example, the application-layer traffic optimization architecture mainly includes an ALTO server (shown in the figure), an ALTO client (shown in the figure), an IP-based dynamic network information unit, an IP-based routing protocol unit, and an ALTO-based network provisioning policy unit, where
the dynamic network information is mainly configured for collecting network-related information.

The routing protocols are mainly configured for running a routing protocol, searching a network optimal path, and ensuring that all routers have a same routing table.

The provisioning policy is mainly configured for providing network provisioning policies.

For example, the Internet service or the third-party application mainly includes a data network (DN), a third content provider, and an external interface, where
the DN may be the Internet, an IP multimedia subsystem (IP), or the like. One of key tasks in the 5G network is to provide a connection to the data network (DN) for a terminal, i.e. a 5G DNN, which is similar to a 4G APN in a 4G network.

The third content provider is mainly configured to provide a service for an application.

The external interface is mainly configured to provide an external interface for an application.

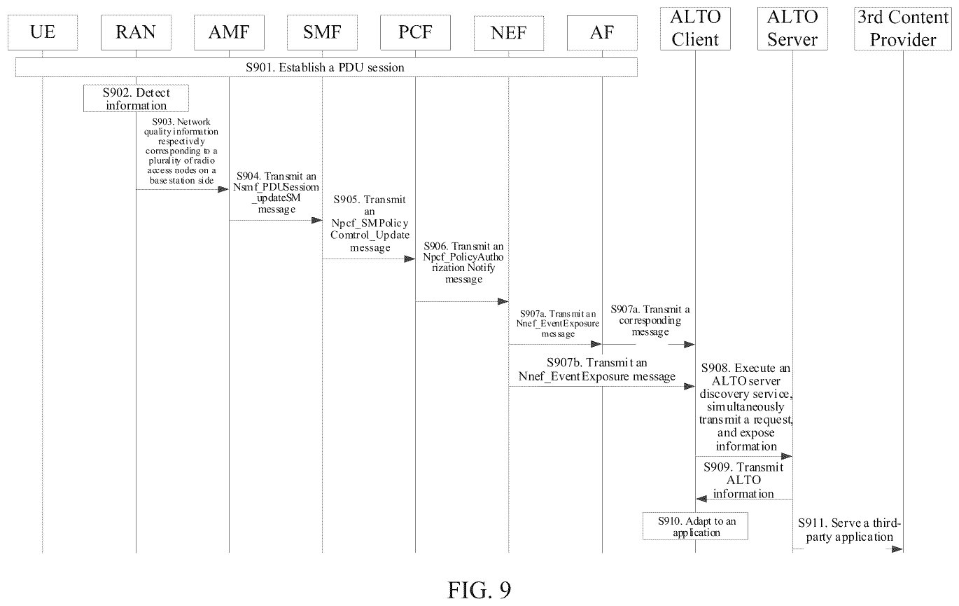

Based on an implementation environment shown in FIG. 8, FIG. 9 is a flowchart of a service processing method according to an embodiment of this application. As shown in FIG. 9, the service processing method includes at least S901 to S911. Detailed descriptions are as follows:

S901: UE initiates a service request, and establishes a protocol data unit (PDU) session between the UE and an ALTO client.

For example, the ALTO client and the AF may be used as a network element separately, or may be merged into one network element. In practical application, adjustment may be made flexibly according to a specific application scene.

S902: The RAN obtains network quality information respectively corresponding to a plurality of radio access nodes on a base station side.

For example, the network quality information may be network quality information on the base station side. Specifically, the network quality information may be the network quality information of an access router on the base station side, and is configured for representing network quality of a network environment in which the access router on the base station side is located. The network quality information mainly includes network indicator information and network status information. The network indicator information includes throughput, delay, a packet loss rate, jitter, and the like. The network status information includes a received signal strength indication (RSSI), reference signal receiving power (RSRP), reference signal receiving quality (RSRQ), a signal to interference plus noise ratio (SINR), received signal code power (RSCP), and the like.

For example, the RAN may further obtain attribute information of the UE. The attribute information is configured for representing a receiving/transmitting state of the UE receiving/transmitting data.

S903: The RAN notifies an AMF of network quality information respectively corresponding to a plurality of radio access nodes on the base station side.

S904: The AMF transmits an Nsmf_PDUSession_UpdateSM message to an SMF by using an N11 interface.

The Nsmf_PDUSession_UpdateSM message is obtained by converting the network quality information, respectively corresponding to the plurality of radio access nodes, received by the AMF and transmitted by the RAN.

S905: The SMF transmits an Npcf_SMPolicyControl_Update message to the PCF by using an N7 interface.

The Npcf_SMPolicyControl_Update message is obtained by converting the Nsmf_PDUSession_UpdateSM message received by the SMF and transmitted by the AMF.

S906: The PCF transmits an Npcf_Policy_Authorization_Notify message to the NEF by using an N5 interface.

The Npcf_PolicyAuthorization_Notify message is obtained by converting the Npcf_SMPolicyControl_Update message received by the PCF and transmitted by the SMF.

S907a: Correspondingly selecting 1, the NEF first transmits an Nnef_EventExposure message to the AF by using an N33 interface, and subsequently, the AF transmits a corresponding message to the ALTO client.

The Nnef_EventExposure message is obtained by converting the Npcf_Policy_Authorization_Notify message received by the NEF and transmitted by the PCF.

S907b: Correspondingly selecting 2, the NEF directly transmits an Nnef_EventExposure message to the ALTO client by using an N33 interface.

The Nnef_EventExposure message is obtained by converting the Npcf_PolicyAuthorization_Notify message received by the NEF and transmitted by the PCF.

In this way, by selecting 1 or selecting 2, the ALTO client obtains network quality information respectively corresponding to the plurality of radio access nodes on the base station side.

S908: The ALTO client performs an ALTO server discovery service to discover the ALTO server, and simultaneously transmits an ALTO information obtaining request and network quality information respectively corresponding to the plurality of radio access nodes on the base station side to an ALTO server.

In this way, the ALTO server obtains the network quality information respectively corresponding to the plurality of radio access nodes on the base station side.

S909: The ALTO server transmits the ALTO information respectively corresponding to the plurality of radio access nodes on the base station side to the ALTO client based on the ALTO information obtaining request transmitted by the ALTO client.

For example, the ALTO information is configured for representing resources of an access router on the base station side, and the resources include a computing resource, a storage resource, and the like. The ALTO information may be generated by the ALTO server based on the resource information, respectively corresponding to the plurality of radio access nodes, obtained by statistical analysis and received attribute information of the UE.

S910: The ALTO client selects a target radio access node for processing the service request from the plurality of radio access nodes based on the network quality information and ALTO information respectively corresponding to a plurality of radio access nodes on the base station side, so as to adapt to an application in the UE by using the target radio access node, and process the service request.

The network quality information respectively corresponding to the plurality of radio access nodes on the base station side may be considered as network information exposed on the RAN side, and the ALTO information may be considered as Internet information exposed on the ALTO server side.

S911: The ALTO server provides an Internet service to a third-party application by using an external interface.

In addition, for detailed descriptions of S901 to S911 shown in FIG. 9, refer to the foregoing embodiment. Details are not described herein again.

In this embodiment of this application, the ALTO client obtains network information (i.e. a network quality status of a network environment in which the radio access nodes are located) exposed on the RAN side from the 5G network, and based on the ALTO information (i.e. a resource status of the radio access nodes) of the ALTO server, the target radio access node for processing the service request can be determined more accurately and properly, to adapt to a corresponding application, resulting in more proper and timely processing of corresponding services.

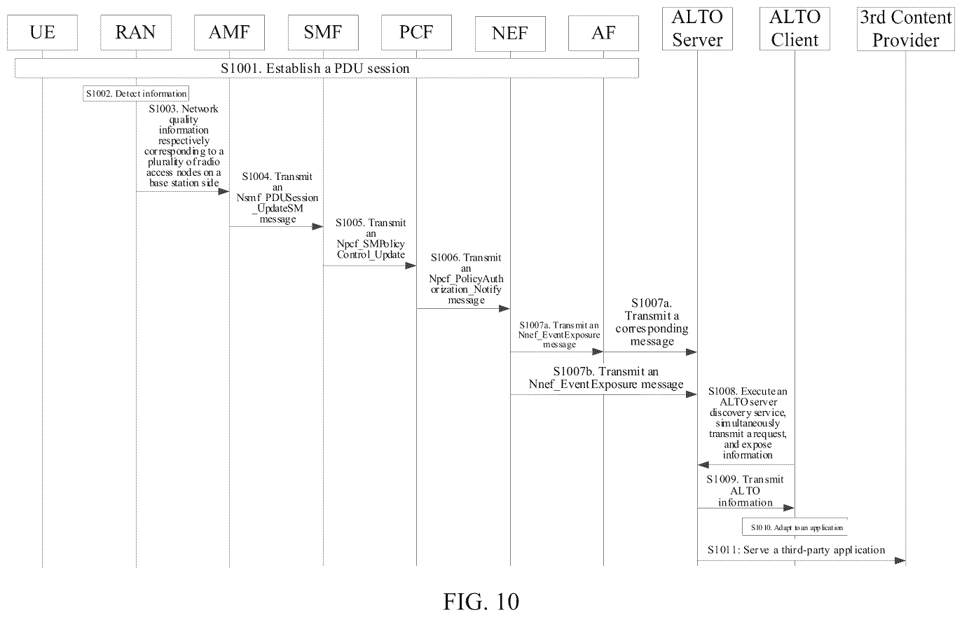

Based on an implementation environment shown in FIG. 8, FIG. 10 is a flowchart of a service processing method according to an embodiment of this application. As shown in FIG. 10, the service processing method includes at least S1001 to S1011. Detailed descriptions are as follows:

S1001: UE initiates a service request, and establishes a PDU session between the UE and an ALTO server.

For example, the ALTO server and an AF may be respectively used as a network element, or may be merged into one network element. In practical application, adjustment may be made flexibly according to a specific application scene.

S1002: The RAN obtains network quality information respectively corresponding to a plurality of radio access nodes on a base station side.

For example, the network quality information may be network quality information on the base station side. Specifically, the network quality information may be the network quality information of an access router on the base station side, and is configured for representing network quality of a network environment in which the access router on the base station side is located. The network quality information mainly includes network indicator information and network status information. The network indicator information includes throughput, delay, a packet loss rate, jitter, and the like. The network status information includes an RSSI, an RSRP, an RSRQ, an SINR, an RSCP, and the like.

For example, the RAN may further obtain attribute information of the UE. The attribute information is configured for representing a receiving/transmitting state of the UE receiving/transmitting data.

S1003: The RAN notifies an AMF of network quality information respectively corresponding to a plurality of radio access nodes on a base station side.

S1004: The AMF transmits an Nsmf_PDUSession_UpdateSM message to an SMF by using an N11 interface.

The Nsmf_PDUSession_UpdateSM message is obtained by converting the network quality information, respectively corresponding to the plurality of radio access nodes, received by the AMF and transmitted by the RAN.

S1005: The SMF transmits an Npcf_SMPolicyControl_Update message to the PCF by using an N7 interface.

The Npcf_SMPolicyControl_Update message is obtained by converting the Nsmf_PDUSession_UpdateSM message received by the SMF and transmitted by the AMF.

S1006: The PCF transmits an Npcf_PolicyAuthorization_Notify message to the NEF by using an N5 interface.

The Npcf_PolicyAuthorization_Notify message is obtained by converting the Npcf_SMPolicyControl_Update message received by the PCF and transmitted by the SMF.

S1007a: Correspondingly selecting 1, the NEF first transmits an Nnef_EventExposure message to the AF by using an N33 interface, and subsequently, the AF transmits a corresponding message to an ALTO server.

The Nnef_EventExposure message is obtained by converting the Npcf_Policy_Authorization_Notify message received by the NEF and transmitted by the PCF.

S1007b: Correspondingly selecting 2, the NEF directly transmits an Nnef_EventExposure message to the ALTO server by using the N33 interface.

The Nnef_EventExposure message is obtained by converting the Npcf_PolicyAuthorization_Notify message received by the NEF and transmitted by the PCF.

In this way, by selecting 1 or selecting 2, the ALTO server obtains the network quality information respectively corresponding to the plurality of radio access nodes on the base station side.

S1008: The ALTO client executes an ALTO server discovery service to discover the ALTO server, and transmits the ALTO information, the base station side information obtaining request, and the attribute information of the UE to the ALTO server. The ALTO client may directly obtain the attribute information of the UE from the UE side, and the attribute information may be the same as or different from the attribute information of the UE obtained by the RAN side.

In this way, the ALTO server obtains the network quality information respectively corresponding to the plurality of radio access nodes on the base station side.

S1009: The ALTO server transmits the network quality information respectively corresponding to the plurality of radio access nodes on the base station side and the ALTO information to the ALTO client based on the ALTO information transmitted by the ALTO client and a base station side information obtaining request.

For example, the ALTO information is configured for representing resources of an access router on the base station side, and the resources include a computing resource, a storage resource, and the like. The ALTO information may be generated by the ALTO server based on the resource information, respectively corresponding to the plurality of radio access nodes, obtained by statistical analysis and received attribute information of the UE.

S1010: The ALTO client selects a target radio access node for processing the service request from the plurality of radio access nodes based on the network quality information and ALTO information respectively corresponding to a plurality of radio access nodes on the base station side, so as to adapt to an application in the UE by using the target radio access node, and process the service request.

The network quality information respectively corresponding to the plurality of radio access nodes on the base station side may be considered as network information exposed on the RAN side, and the ALTO information may be considered as Internet information exposed on the ALTO server side.

S1011: The ALTO server provides an Internet service to a third-party application by using an external interface.

In addition, for detailed descriptions of S1001 to S1011 shown in FIG. 10, refer to the foregoing embodiment. Details are not described herein again.

In this embodiment of this application, the ALTO server obtains network information (i.e. a network quality status of a network environment in which the radio access node is located) exposed on the RAN side from the 5G network, and based on the ALTO information (i.e. a resource status of the radio access node) of the ALTO server, the target radio access node for processing the service request can be determined more accurately and properly, to adapt to a corresponding application, resulting in more proper and timely processing of corresponding services.

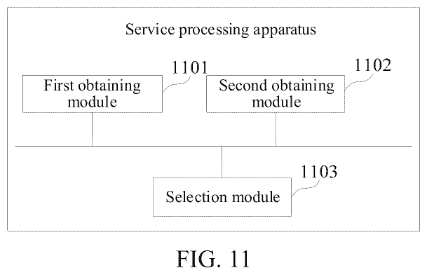

FIG. 11 is a block diagram of a service processing apparatus according to an embodiment of this application. As shown in FIG. 11, the service processing apparatus includes:

a first obtaining module 1101, configured to obtain network quality information respectively corresponding to a plurality of radio access nodes in a radio access network when receiving a service request from user equipment, where the network quality information is configured for representing network quality of a network environment in which the radio access nodes are located;
a second obtaining module 1102, configured to obtain application-layer traffic optimization information respectively corresponding to the plurality of radio access nodes, where the application-layer traffic optimization information is configured for representing resources of the radio access nodes; and
a selection module 1103, configured to select a target radio access node for processing the service request from the plurality of radio access nodes based on the network quality information and the application-layer traffic optimization information.

In an embodiment of this application, the selection module 1103 is specifically configured to:
compute network quality evaluation parameters respectively corresponding to the plurality of radio access nodes based on the network quality information, where the network quality evaluation parameters are in a positive correlation with network quality;
compute resource evaluation parameters respectively corresponding to the plurality of radio access nodes based on the application-layer traffic optimization information, where the resource evaluation parameters are in a positive correlation with resource margins; and
select a target radio access node for processing the service request from the plurality of radio access nodes based on the network quality evaluation parameters and the resource evaluation parameters.

In an embodiment of this application, the network quality information includes numerical values corresponding to a plurality of different types of network indicators. The selection module 1103 is further specifically configured to:
compute, for each radio access node, the network quality evaluation parameter corresponding to the radio access node based on the numerical values corresponding to the plurality of different types of network indicators.

In an embodiment of this application, the application-layer traffic optimization information includes numerical values corresponding to a plurality of different types of resources. The selection module 1103 is further specifically configured to:
compute, for each radio access node, a resource evaluation parameter corresponding to the radio access node based on the numerical values corresponding to the plurality of different types of resources.

In an embodiment of this application, the selection module 1103 is further specifically configured to:
select a radio access node corresponding to that the network quality evaluation parameter is greater than a preset network quality evaluation threshold, and the resource evaluation parameter is greater than a preset resource evaluation threshold from the plurality of radio access nodes; and
use the selected radio access node as the target radio access node for processing the service request.

In an embodiment of this application, the selection module 1103 is further specifically configured to:
select a first candidate radio access node corresponding to that the network quality evaluation parameter is greater than the preset network quality evaluation threshold from the plurality of radio access nodes, and select a radio access node corresponding to that the resource evaluation parameter is greater than the preset resource evaluation threshold from the first candidate radio access nodes; or
select a second candidate radio access node corresponding to that the resource evaluation parameter is greater than a preset resource evaluation threshold from the plurality of radio access nodes, and select a radio access node corresponding to that the network quality evaluation parameter is greater than a preset network quality evaluation threshold from the second candidate radio access nodes.

In an embodiment of this application, the radio access node includes an access router. The first obtaining module 1101 is specifically configured to receive network quality information respectively corresponding to a plurality of access routers and transmitted by a radio access network, where the network quality information is obtained by the radio access network collecting the network quality of a network environment in which the plurality of access routers are located.

In an embodiment of this application, the first obtaining module 1101 is further specifically configured to:
receive the network quality information respectively corresponding to the plurality of access routers and transmitted by the radio access network sequentially through a plurality of network devices in a core network.

In an embodiment of this application, the service processing method is performed by an application-layer traffic optimization client. The second obtaining module 1102 is further specifically configured to:
obtain attribute information corresponding to user equipment, where the attribute information is configured for representing a receiving/transmitting state in which the user equipment receives/transmits data; and
receive resource information respectively corresponding to the plurality of radio access nodes and transmitted by an application-layer traffic optimization server corresponding to the application-layer traffic optimization client, where the resource information is obtained by the application-layer traffic optimization server performing statistical analysis respectively on the resource of each radio access node; and
obtain application-layer traffic optimization information respectively corresponding to the plurality of radio access nodes based on the attribute information and the resource information.

In an embodiment of this application, the service processing apparatus further includes:
a first transmitting module, configured to transmit the service request to the target radio access node, to cause the target radio access node to process the service request.

In an embodiment of this application, the service processing method is performed by an application-layer traffic optimization server. The second obtaining module 1102 is further specifically configured to:
perform statistical analysis respectively on resources of the plurality of radio access nodes to obtain resource information respectively corresponding to the plurality of radio access nodes;
receive attribute information corresponding to user equipment and transmitted by an application-layer traffic optimization client corresponding to the application-layer traffic optimization server, where the attribute information is configured for representing a receiving/transmitting state in which the user equipment receives/transmits data; and
obtain the application-layer traffic optimization information respectively corresponding to the plurality of radio access nodes based on the resource information and the attribute information.

In an embodiment of this application, the service processing apparatus further includes:
a second transmitting module, configured to transmit identifier information of the target radio access node to the application-layer traffic optimization client, so as to transmit the service request to the target radio access node by using the application-layer traffic optimization client, causing the target radio access node to process the service request.

In an embodiment of this application, the service processing apparatus further includes:
an exposure module, configured to expose the network quality information and the application-layer traffic optimization information to a specified application, where the exposed network quality information and application-layer traffic optimization information are configured for the specified application to process a specified service based on the exposed network quality information and application-layer traffic optimization information.

In addition, the apparatus provided in the foregoing embodiment and the method provided in the foregoing embodiment are based on a same concept. The specific manners of performing operations by each module and unit of the apparatus have been described in detail in the method embodiment.

An embodiment of this application further provides an electronic device, including: one or more processors; and a memory, configured to store one or more programs, the one or more programs, when executed by the one or more processors, causing the electronic device to implement the foregoing service processing method.

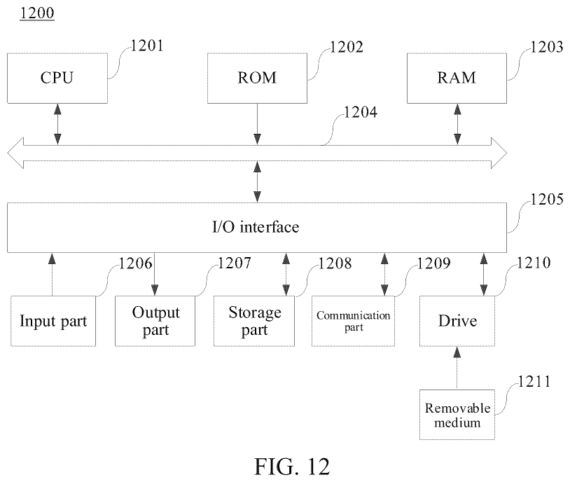

FIG. 12 is a schematic structural diagram of a computer system suitable for implementing an electronic device according to an embodiment of this application.

In addition, a computer system 1200 of the electronic device shown in FIG. 12 is merely an example, and does not constitute any limitation on functions and use ranges of the embodiments of this application.

As shown in FIG. 12, the computer system 1200 includes a central processing unit (CPU) 1201, which may perform various suitable actions and processing based on a program stored in a read-only memory (ROM) 1202 or a program loaded from a storage part 1208 into a random access memory (RAM) 1203, for example, perform the method described in the foregoing embodiments. The RAM 1203 further stores various programs and data required for system operations. The CPU 1201, the ROM 1202, and the RAM 1203 are connected to each other through a bus 1204. An input/output (I/O) interface 1205 is alternatively connected to the bus 1204.

The following components are connected to the I/O interface 1205: an input part 1206 including a keyboard, a mouse, and the like; an output part 1207 including a cathode ray tube (CRT), a liquid crystal display (LCD), a speaker, or the like; a storage part 1208 including a hard disk, or the like; and a communication part 1209 including a network interface card such as a local area network (LAN) card and a modem. The communication part 1209 performs communication processing by using a network such as the Internet. A drive 1210 is also connected to the I/O interface 1205 as required. A removable medium 1211, such as a magnetic disk, an optical disc, a magneto-optical disk, or a semiconductor memory, is installed on the drive 1210 as required, so that a computer program read from the removable medium is installed into the storage part 1208 as required.

Particularly, according to an embodiment of this application, the processes described in the following by referring to the flowcharts may be implemented as computer software programs. For example, an embodiment of this application includes a computer program product. The computer program product includes a computer program stored in a computer-readable medium. The computer program includes a computer program configured for performing a method shown in the flowchart. In this embodiment, the computer program may be downloaded and installed from a network through the communication part 1209, and/or installed from the removable medium 1211. When the computer program is executed by the CPU 1201, the various functions defined in the system of this application are executed.

In addition, the computer-readable medium described in the embodiments of this application may be a computer-readable signal medium or a computer-readable storage medium or any combination of the above. The computer-readable medium may be, for example, an electrical, magnetic, optical, electromagnetic, infrared, or semiconductor system, apparatus, or device, or any combination thereof. More specific examples of the computer-readable medium may include, but are not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable medium may be any tangible medium containing or storing a program, and the program may be used by or used in combination with an instruction execution system, an apparatus, or a device. In this application, the computer-readable signal medium may include a data signal transmitted in a base band or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may transmit, propagate, or transmit a program that is used by or used in conjunction with an instruction execution system, an apparatus, or a device. The computer program included in the computer-readable medium may be transmitted by using any suitable medium, including but not limited to: a wireless medium, a wired medium, or any suitable combination of the above.

The flowcharts and block diagrams in the accompanying drawings illustrate possible system architectures, functions and operations that may be implemented by a system, a method, and a computer program product according to various embodiments of this application. Each box in a flowchart or a block diagram may represent a module, a program segment, or a part of code. The module, the program segment, or the part of code includes one or more executable instructions configured for implementing specified logic functions. In some implementations used as substitutes, functions marked in boxes may alternatively occur in a sequence different from that marked in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

A related unit described in the embodiments of this application may be implemented in a software manner, or may be implemented in a hardware manner, and the unit described can also be set in a processor. Names of the units do not constitute a limitation on the units in a specific case.

Another aspect of this application further provides a non-transitory computer-readable medium, having a computer program stored therein. The computer program, when executed by a processor, implements the service processing method as described above. The computer-readable medium may be included in the electronic device described in the foregoing embodiments, or may exist alone and is not disposed in the electronic device.

Another aspect of this application further provides a computer program product or a computer program, including computer instructions, the computer instructions being stored in a computer-readable medium. A processor of a computer device reads the computer instructions from the computer-readable medium, and the processor executes the computer instructions to cause the computer device to perform the service processing method provided in the foregoing various embodiments.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module can be part of an overall module that includes the functionalities of the module. What is described above is merely exemplary embodiments of this application, and is not intended to limit the embodiments of this application. A person of ordinary skill in the art can easily make equivalent changes or modifications according to the main concept and spirit of this application. Therefore, the protection scope of this application is subject to the protection scope specified in the claims.

What is claimed is:

1. A service processing method performed by an electronic device acting as an application-layer traffic optimization system, the method comprising:
obtaining network quality information respectively corresponding to a plurality of radio access nodes in a radio access network in response to a service request from a user equipment;
obtaining application-layer traffic optimization information respectively corresponding to the plurality of radio access nodes, wherein the application-layer traffic optimization information is configured for representing resources of the radio access nodes; and
selecting a target radio access node for processing the service request from the plurality of radio access nodes based on the network quality information and the application-layer traffic optimization information.

2. The method according to claim 1, wherein the selecting a target radio access node for processing the service request from the plurality of radio access nodes based on the network quality information and the application-layer traffic optimization information comprises:
computing network quality evaluation parameters respectively corresponding to the plurality of radio access nodes based on the network quality information, wherein the network quality evaluation parameters are in a positive correlation with the network quality;
computing resource evaluation parameters respectively corresponding to the plurality of radio access nodes based on the application-layer traffic optimization information, wherein the resource evaluation parameters are in a positive correlation with resource margins; and
selecting a target radio access node for processing the service request from the plurality of radio access nodes based on the network quality evaluation parameters and the resource evaluation parameters.

3. The method according to claim 2, wherein the network quality information comprises numerical values corresponding to a plurality of different types of network indicators; and
the computing network quality evaluation parameters respectively corresponding to the plurality of radio access nodes based on the network quality information comprises:
computing, for each radio access node, a network quality evaluation parameter corresponding to the radio access node based on the numerical values corresponding to the plurality of different types of network indicators.

4. The method according to claim 2, wherein the application-layer traffic optimization information comprises numerical values corresponding to a plurality of types of resources; and
the computing resource evaluation parameters respectively corresponding to the plurality of radio access nodes based on the application-layer traffic optimization information comprises:
computing, for each radio access node, a resource evaluation parameter corresponding to the radio access node based on the numerical values corresponding to the plurality of types of resources.

5. The method according to claim 2, wherein the selecting a target radio access node for processing the service request from the plurality of radio access nodes based on the network quality evaluation parameters and the resource evaluation parameters comprises:
selecting, from the plurality of radio access nodes, a radio access node whose network quality evaluation parameter is greater than a preset network quality evaluation threshold, and whose resource evaluation parameter is greater than a preset resource evaluation threshold; and
using the selected radio access node as the target radio access node for processing the service request.

6. The method according to claim 5, wherein the electing, from the plurality of radio access nodes, a radio access node whose network quality evaluation parameter is greater than a preset network quality evaluation threshold, and whose resource evaluation parameter is greater than a preset resource evaluation threshold comprises:
selecting, from the plurality of radio access nodes, first candidate radio access nodes whose network quality evaluation parameters are greater than the preset network quality evaluation threshold, and selecting, from the first candidate radio access nodes, a radio access node whose resource evaluation parameter is greater than the preset resource evaluation threshold; or
selecting, from the plurality of radio access nodes, second candidate radio access nodes whose resource evaluation parameter is greater than the preset resource evaluation threshold, and selecting, from the second candidate radio access nodes, a radio access node whose network quality evaluation parameter is greater than the preset network quality evaluation threshold.

7. The method according to claim 1, wherein the wireless access node comprises an access router;
the obtaining network quality information respectively corresponding to a plurality of radio access nodes in a radio access network comprises:
receiving the network quality information respectively corresponding to a plurality of access routers and transmitted by a radio access network, wherein the network quality information is obtained from collecting the network quality of a network environment in which the plurality of access routers are located by the radio access network.

8. The method according to claim 7, wherein the receiving the network quality information respectively corresponding to a plurality of access routers and transmitted by a radio access network comprises:
receiving network quality information respectively corresponding to a plurality of access routers and transmitted by the radio access network sequentially through a plurality of network devices in a core network.

9. The method according to claim 1, wherein the obtaining application-layer traffic optimization information respectively corresponding to the plurality of radio access nodes comprises:
obtaining attribute information corresponding to the user equipment, wherein the attribute information is configured for representing a receiving/transmitting state in which the user equipment receives/transmits data; and
receiving resource information respectively corresponding to the plurality of radio access nodes and transmitted by an application-layer traffic optimization server, wherein the resource information is obtained from performing statistical analysis on the resource of each radio access node by the application-layer traffic optimization server; and
obtaining the application-layer traffic optimization information respectively corresponding to the plurality of radio access nodes based on the attribute information and the resource information.

10. The method according to claim 1, wherein the obtaining application-layer traffic optimization information respectively corresponding to the plurality of radio access nodes comprises:
performing statistical analysis respectively on resources of the plurality of radio access nodes to obtain resource information respectively corresponding to the plurality of radio access nodes;
receiving attribute information corresponding to the user equipment and transmitted by an application-layer traffic optimization client corresponding to the application-layer traffic optimization server, wherein the attribute information is configured for representing a receiving/transmitting state in which the user equipment receives/transmits data; and
obtaining the application-layer traffic optimization information respectively corresponding to the plurality of radio access nodes based on the resource information and the attribute information.

11. The method according to claim 1, the method further comprising:
after obtaining the application-layer traffic optimization information respectively corresponding to the plurality of radio access nodes:
exposing the network quality information and the application-layer traffic optimization information to a specified application, wherein the exposed network quality information and application-layer traffic optimization information are configured for the specified application to process a specified service based on the exposed network quality information and application-layer traffic optimization information.

12. An electronic device, comprising:
one or more processors; and
a memory, configured to store one or more programs, the one or more programs, when executed by the electronic device, causing the electronic device to implement a service processing method including:
obtaining network quality information respectively corresponding to a plurality of radio access nodes in a radio access network in response to a service request from a user equipment;
obtaining application-layer traffic optimization information respectively corresponding to the plurality of radio access nodes, wherein the application-layer traffic optimization information is configured for representing resources of the radio access nodes; and
selecting a target radio access node for processing the service request from the plurality of radio access nodes based on the network quality information and the application-layer traffic optimization information.

13. The electronic device according to claim 12, wherein the selecting a target radio access node for processing the service request from the plurality of radio access nodes based on the network quality information and the application-layer traffic optimization information comprises:
computing network quality evaluation parameters respectively corresponding to the plurality of radio access nodes based on the network quality information, wherein the network quality evaluation parameters are in a positive correlation with the network quality;
computing resource evaluation parameters respectively corresponding to the plurality of radio access nodes based on the application-layer traffic optimization information, wherein the resource evaluation parameters are in a positive correlation with resource margins; and
selecting a target radio access node for processing the service request from the plurality of radio access nodes based on the network quality evaluation parameters and the resource evaluation parameters.

14. The electronic device according to claim 13, wherein the network quality information comprises numerical values corresponding to a plurality of different types of network indicators; and
the computing network quality evaluation parameters respectively corresponding to the plurality of radio access nodes based on the network quality information comprises:
computing, for each radio access node, a network quality evaluation parameter corresponding to the radio access node based on the numerical values corresponding to the plurality of different types of network indicators.

15. The electronic device according to claim 13, wherein the application-layer traffic optimization information comprises numerical values corresponding to a plurality of types of resources; and
the computing resource evaluation parameters respectively corresponding to the plurality of radio access nodes based on the application-layer traffic optimization information comprises:
computing, for each radio access node, a resource evaluation parameter corresponding to the radio access node based on the numerical values corresponding to the plurality of types of resources.

16. The electronic device according to claim 12, wherein the wireless access node comprises an access router;
the obtaining network quality information respectively corresponding to a plurality of radio access nodes in a radio access network comprises:
receiving the network quality information respectively corresponding to a plurality of access routers and transmitted by a radio access network, wherein the network quality information is obtained from collecting the network quality of a network environment in which the plurality of access routers are located by the radio access network.

17. The electronic device according to claim 12, wherein the obtaining application-layer traffic optimization information respectively corresponding to the plurality of radio access nodes comprises:
obtaining attribute information corresponding to the user equipment, wherein the attribute information is configured for representing a receiving/transmitting state in which the user equipment receives/transmits data; and
receiving resource information respectively corresponding to the plurality of radio access nodes and transmitted by an application-layer traffic optimization server, wherein the resource information is obtained from performing statistical analysis on the resource of each radio access node by the application-layer traffic optimization server; and
obtaining the application-layer traffic optimization information respectively corresponding to the plurality of radio access nodes based on the attribute information and the resource information.

18. The electronic device according to claim 12, wherein the obtaining application-layer traffic optimization information respectively corresponding to the plurality of radio access nodes comprises:
performing statistical analysis respectively on resources of the plurality of radio access nodes to obtain resource information respectively corresponding to the plurality of radio access nodes;
receiving attribute information corresponding to the user equipment and transmitted by an application-layer traffic optimization client corresponding to the application-layer traffic optimization server, wherein the attribute information is configured for representing a receiving/transmitting state in which the user equipment receives/transmits data; and
obtaining the application-layer traffic optimization information respectively corresponding to the plurality of radio access nodes based on the resource information and the attribute information.

19. The electronic device according to claim 12, wherein the method further comprises:
after obtaining the application-layer traffic optimization information respectively corresponding to the plurality of radio access nodes:
exposing the network quality information and the application-layer traffic optimization information to a specified application, wherein the exposed network quality information and application-layer traffic optimization information are configured for the specified application to process a specified service based on the exposed network quality information and application-layer traffic optimization information.

20. A non-transitory computer-readable medium, having a computer program stored therein, the computer program, when executed by a processor of an electronic device, causing the electronic device to implement a service processing method including:
obtaining network quality information respectively corresponding to a plurality of radio access nodes in a radio access network in response to a service request from a user equipment;
obtaining application-layer traffic optimization information respectively corresponding to the plurality of radio access nodes, wherein the application-layer traffic optimization information is configured for representing resources of the radio access nodes; and
selecting a target radio access node for processing the service request from the plurality of radio access nodes based on the network quality information and the application-layer traffic optimization information.
